(19) United States
(12) Patent Application Publication
(10) Pub. No.: US 2025/0374036 A1
(43) Pub. Date: Dec. 4, 2025

(54) RANGING METHOD AND RANGING DEVICE

(71) Applicant: Beijing Xiaomi Mobile Software Co., Ltd., Beijing (CN)

(72) Inventors: Haoran LIANG, Beijing (CN); Yang SHEN, Beijing (CN); Wei LU, Beijing (CN)

(73) Assignee: Beijing Xiaomi Mobile Software Co., Ltd., Beijing (CN)

(21) Appl. No.: 18/870,969

(22) PCT Filed: Jun. 2, 2022
(86) PCT No.: PCT/CN2022/097014

§ 371 Date: Dec. 2, 2024

(51) Int. Cl. H04W 12/02; H04W 4/02

(52) U.S. Cl. CPC H04W 12/02; H04W 4/023

(57) ABSTRACT

A ranging method is provided. The method includes: receiving a ranging request message, which is sent by a first terminal device; according to a privacy profile stored in a second terminal device, performing privacy verification of the ranging request message; and sending a ranging response message to the first terminal device, wherein the ranging response message is used to determine whether to accept a ranging request of the ranging request message.

### CROSS REFERENCE TO RELATED APPLICATIONS

The present disclosure is the U.S. national phase application of International Application No. PCT/CN2022/097014 filed on Jun. 2, 2022, the content of which is incorporated herein by reference in its entirety for all purposes.

### TECHNICAL FIELD

The present disclosure relates to the field of communication technology, in particular, to a ranging method and a ranging device.

### BACKGROUND

The ranging service as defined in 3GPP TR 22.855 refers to determination of the distance between two User Equipment (UE) and/or the direction of one UE from the other UE via a direct communication connection. The UE which needs to perform ranging on another UE is referred to as the reference UE, and the UE on which the ranging is performed is referred to as the target UE.

### SUMMARY

A first aspect of the present disclosure provides a ranging method. The method is performed by a second terminal device, and includes: receiving a ranging request message sent by a first terminal device; performing privacy verification of the ranging request message based on a privacy profile stored on the second terminal device; and sending a ranging response message to the first terminal device, wherein the ranging response message is used to determine whether to accept a ranging request.

A second aspect of the present disclosure provides a ranging method. The method is performed by a first terminal device, and includes: sending a ranging request message to a second terminal device, wherein the ranging request message is used to request for ranging to be performed on the second terminal device; and receiving a ranging response message sent by the second terminal device, wherein the ranging response message is used to determine whether to accept a ranging request.

A third aspect of the present disclosure provides a communication device including a processor and a memory, wherein the memory stores a computer program, and the processor is configured to execute the computer program stored in the memory, to cause the ranging method described in the first aspect to be performed by the device.

A fourth aspect of the present disclosure provides a communication device including a processor and a memory, wherein the memory stores a computer program, and the processor is configured to execute the computer program stored in the memory, to cause the ranging method described in the second aspect to be performed by the device.

A fifth aspect of the present disclosure provides a communication device including a processor and an interface circuit, wherein the interface circuit is configured to receive and transmit code instructions to the processor; and the processor is configured to run the code instructions to cause the ranging method described in the first aspect to be performed.

A sixth aspect of the present disclosure provides a communication device including a processor and an interface circuit, wherein the interface circuit is configured to receive and transmit code instructions to the processor; and the processor is configured to run the code instructions to cause the ranging method described in the second aspect to be performed.

A seventh aspect of the present disclosure provides a computer-readable storage medium having instructions stored thereon, which when executed, cause the ranging method described in the first aspect to be performed.

An eighth aspect of the present disclosure provides a computer-readable storage medium having instructions stored thereon, which when executed, cause the ranging method described in the second aspect to be performed.

A ninth aspect of the present disclosure provides a computer program, which when runs on a computer, causes the computer to implement the ranging method described in the first aspect.

A tenth aspect of the present disclosure provides a computer program, which when runs on a computer, causes the computer to implement the ranging method described in the second aspect.

The additional aspects and advantages of the present disclosure will be partially presented in the following description, some of which will become apparent from the following description, or learned through practice of the present disclosure.

### BRIEF DESCRIPTION OF THE DRAWINGS

In order to provide a clearer explanation of the technical solutions in embodiments of the present disclosure or in the background, the drawings required for use in the embodiments or the background will be described in the following.

FIG. 1a is a schematic diagram of an architecture of a communication system according to embodiments of the present disclosure;

FIG. 1b is a schematic diagram of providing a ranging service to a terminal device with or without network coverage;

FIG. 2 is a flowchart of a ranging method according to embodiments of the present disclosure;

FIG. 3 is a flowchart of a ranging method according to embodiments of the present disclosure;

FIG. 4 is a flowchart of a ranging method according to embodiments of the present disclosure;

FIG. 5 is a flowchart of a ranging method according to embodiments of the present disclosure;

FIG. 6 is a flowchart of a ranging method according to embodiments of the present disclosure;

FIG. 7 is a flowchart of a ranging method according to embodiments of the present disclosure;

FIG. 8 is a flowchart of a ranging method according to embodiments of the present disclosure;

FIG. 9 is a schematic diagram of a structure of a ranging apparatus according to embodiments of the present disclosure;

FIG. 10 is a schematic diagram of a structure of a ranging apparatus according to embodiments of the present disclosure;

FIG. 11 is a schematic diagram of a structure of a device for ranging according to embodiments of the present disclosure; and

FIG. 12 is a schematic diagram of a structure of a chip according to embodiments of the present disclosure.

### DETAILED DESCRIPTION

A detailed explanation of embodiments will be provided herein, which are illustrated in the drawings. The following description when referring to the drawings, unless otherwise indicated, the same reference numerals in different drawings represent the same or similar elements. The embodiments described in the following do not represent all embodiments consistent with the present disclosure. On the contrary, the embodiments are only examples of devices and methods consistent with some aspects of the present disclosure as detailed in the appended claims.

Terms used in present disclosure are for the purpose of describing specific embodiments only and are not intended to limit the present disclosure. The singular forms “a” and “the” used in the present disclosure and the appended claims are also intended to include the multiple forms, unless the context clearly indicates otherwise. It should also be understood that the term “and/or” used herein refers to and includes any or all possible combinations of one or more related items listed.

It should be understood that although various information may be described using terms such as first, second, and third in present disclosure, such information should not be limited to these terms. These terms are only used to distinguish information of the same type from each other. For example, without departing from the scope of the present disclosure, the first information can also be referred to as the second information, and similarly, the second information can also be referred to as the first information. For example, the words “if” and “as if” used herein can be interpreted as “when”, or “while”, or “in response to determination”, depending on the context.

Embodiments of the present disclosure will be described in detail in the following, and examples of the embodiments are shown in the drawings, throughout which the same or similar reference numerals represent the same or similar elements. The embodiments described below with reference to the drawings are exemplary and are intended to explain the present disclosure, and should not be construed as limiting the present disclosure.

In order to better understand the ranging method provided in embodiments of the present disclosure, the communication system to which embodiments of the present disclosure are applied will be first described in the following.

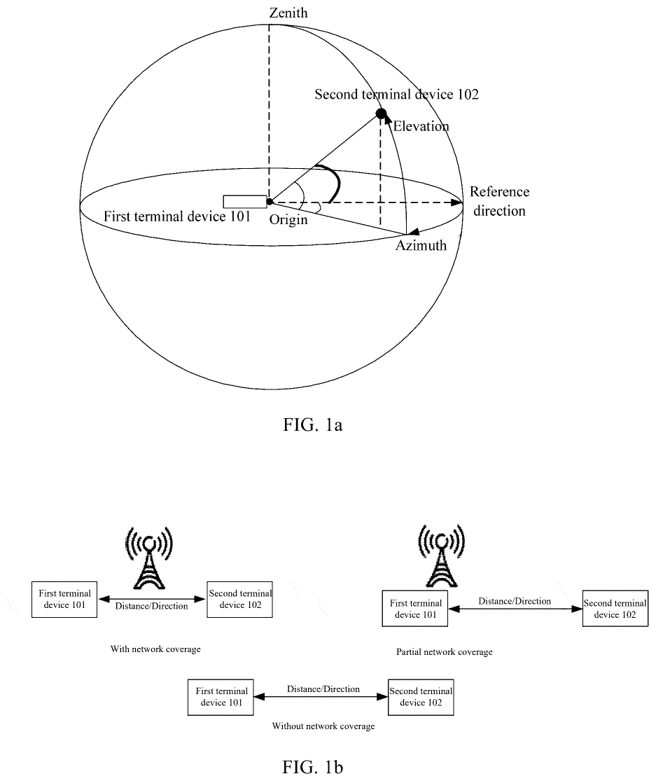

As shown in FIG. 1a, a schematic diagram of an architecture of a communication system according to embodiment of the present disclosure is provided. The communication system can include, but is not limited to, a first terminal device and a second terminal device. The number and the form of devices shown in FIG. 1a are for illustrative purpose only and do not constitute a limitation on embodiments of the present disclosure. In practical applications, two or more network devices and two or more terminal devices can be included. In the communication system shown in FIG. 1a, one first terminal device 101 and one second terminal device 102 are included, taking as an example.

It should be noted that technical solutions of embodiments of the present disclosure can be applied to various communication systems, such as Long Term Evolution (LTE) systems, 5th Generation Mobile Communication systems, 5G New Radio systems, or other future new mobile communication systems.

The first terminal device 101 and the second terminal device 102 in embodiments of the present disclosure are entities on the user side used for receiving or transmitting signals, such as mobile phones. The terminal devices can also be referred to as terminals, user equipment (UE), mobile stations (MS), mobile terminals (MT), etc. The terminal devices can be devices with communication functionality, such as cars, intelligent vehicles, mobile phones, wearable devices, pads, computers with wireless transmission and reception functionality, virtual reality (VR) terminal devices, augmented reality (AR) terminal devices, wireless terminal devices in industrial control, wireless terminal devices in self-driving, wireless terminal devices in remote medical surgery, wireless terminal devices in smart grid, wireless terminal devices in transportation safety, wireless terminal devices in smart cities, and wireless terminal devices in smart homes, etc. Embodiments of the present disclosure do not limit the specific technology and device form adopted by the terminal device.

The ranging service as defined in 3GPP TR 22.855 refers to determination of the distance between two terminal devices and/or the direction of one terminal device from the other terminal device via a direct communication connection. The terminal device which needs to perform ranging on another terminal device can be referred to as the reference terminal device (the first terminal device 101 in embodiments of the present disclosure), and the terminal device on which the ranging is performed can be referred to as the target terminal device (the second terminal device 102 in embodiments of the present disclosure).

As shown in FIG. 1a, the first terminal device 101 has a reference plane and a reference direction. The direction of the second terminal device 102 to the first terminal device 101 is an angle between a line connecting the first terminal device 101 with the second terminal device 102 and the reference direction, which is represented by an azimuth direction and an elevation direction. The azimuth direction of the second terminal device 102 is an angle formed between the projection of the line connecting the first terminal device 101 with the second terminal device 102 on a plane orthogonal to the zenith where the reference direction is located and the reference direction. The elevation direction of the second terminal device 102 is an angle above the horizontal plane.

The ranging service can be supported with or without 5G network coverage. As shown in FIG. 1b, a schematic diagram of providing a ranging service to a terminal device with or without network coverage is provided. If the licensed frequency band is used for ranging, it should be fully under operator control.

The first terminal device 101 can directly initiate the ranging procedure by sending a ranging request to the second terminal device 102 on PC5 (underlying direct cellular communication protocol interface). The procedure can be regarded as a terminal-device based ranging procedure. When the first terminal device 101 directly initiates the ranging procedure on PC5, there is no privacy check mechanism, and the first terminal device 101 can obtain highly accurate distance and direction information about the second terminal device 102 without permission from the second terminal device 102, resulting in location privacy leakage. Therefore, when the first terminal device 101 directly initiates the ranging procedure on PC5, a mechanism is required to be designed to protect the privacy of the second terminal device 102.

It can be understood that the communication system described in embodiments of the present disclosure is for the purpose of providing a clearer explanation of, instead of constituting a limitation on, the technical solutions in embodiments of the present disclosure. Those of ordinary skill in the art know that with the evolution of system architectures and the emergence of new business scenes, the technical solutions in some embodiments of the present disclosure are also applicable to similar technical problems.

The ranging method and the ranging apparatus provided by the present disclosure will be described in detail in the following with reference to the drawings.

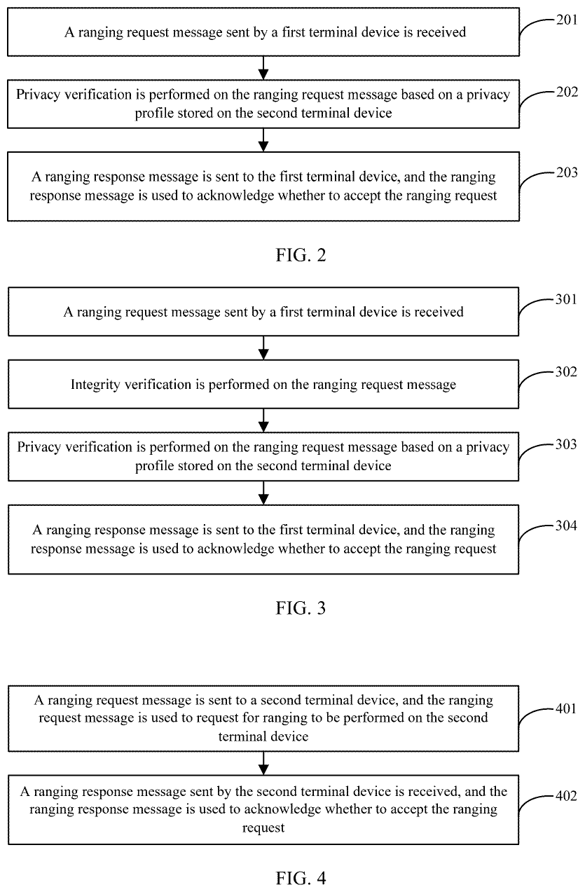

As shown in FIG. 2, a schematic flowchart of a ranging method according to embodiments of the present disclosure is provided. It should be noted that the ranging method in some embodiments of the present disclosure is performed by a second terminal device. The method can be performed independently or in combination with any other embodiment of the present disclosure. As shown in FIG. 2, the method can include the following steps.

In step 201, a ranging request message sent by a first terminal device is received.

In some embodiments of the present disclosure, the second terminal device can receive the ranging request message sent by the first terminal device, to receive the ranging request initiated by the first terminal device, and perform privacy verification of the ranging request message, to determine whether to allow the first terminal device to perform the ranging service.

In some embodiments of the present disclosure, the secure direct connection between the first terminal device and the second terminal device is established based on the Proximity based Service (ProSe) procedure.

In some embodiments, the ranging request message includes identification of the first terminal device, identification of the second terminal device, and a ranging type.

In some embodiments, the ranging type can be directly ranging, meaning that the first terminal device directly initiates the ranging request, alternatively, the ranging type can be the ranging triggered by a third terminal device, meaning that the first terminal device initiates the ranging request under the trigger of the third terminal device.

In some embodiments, in the case where the ranging type is the ranging request initiated by the first terminal device under the trigger of the third terminal device, the ranging request message further includes identification of the third terminal device.

In some embodiments, the ranging request message further includes ranging information, and the ranging information includes at least one of the following: ranging geographic area information, ranging time period information, ranging distance accuracy information, or ranging direction accuracy information.

The ranging geographic area information refers to the geographic area where the ranging task requested by the first terminal device is to be performed.

The ranging time period information refers to the time period during which the ranging task requested by the first terminal device is to be performed.

The ranging distance accuracy information refers to the ranging distance accuracy required for the ranging task requested by the first terminal device.

The ranging direction accuracy information refers to the ranging direction accuracy required for the ranging task requested by the first terminal device.

In some embodiments, the second terminal device can also perform integrity verification of the received ranging request message, and verify whether the request message has been tampered with. If the integrity verification fails, it indicates that the ranging request message has been tampered with, and the second terminal device can reject the ranging request from the first terminal device.

In step 202, privacy verification is performed on the ranging request message based on a privacy profile stored on the second terminal device.

In some embodiments of the present disclosure, the second terminal device can securely store a privacy profile and perform, based on the privacy profile, privacy verification of the ranging request message sent by the first terminal device, to determine whether to allow the first terminal device to perform the ranging service.

It should be noted that in some embodiments of the present disclosure, the second terminal device can deliver the locally stored privacy profile from the application layer to the ProSe layer.

In some embodiments, the privacy profile includes at least one of the following information: a terminal device list, ranging type restriction information, ranging geographic area restriction information, ranging time period restriction information, ranging distance accuracy restriction information, ranging direction accuracy restriction information, or restriction information on number of auxiliary terminal devices.

The terminal device list is a list of trusted terminal devices allowed to be connected to the second terminal device. The terminal device list includes identification of at least one terminal device allowed to be connected to the second terminal device.

The ranging type restriction information refers to the ranging types supported by the second terminal device.

The ranging geographic area restriction information refers to the area allowed for the ranging to be performed on the second terminal device.

The ranging time period restriction information refers to the time period during which the ranging is allowed to be performed on the second terminal device.

The ranging distance accuracy restriction information refers to the highest distance accuracy allowed for the ranging to be performed on the second terminal device.

The ranging direction accuracy restriction information refers to the highest direction accuracy allowed for the ranging to be performed on the second terminal device.

The restriction information on number of auxiliary terminal devices refers to the maximum number of auxiliary terminal devices participating in the collaborative ranging procedure.

It should be noted that auxiliary terminal devices participate in the collaborative ranging procedure, and the more auxiliary terminal devices there are, the higher the accuracy of the final ranging result is. If the first terminal device initiates the ranging request under the trigger of the third terminal device, then the first terminal device is the auxiliary terminal device. The third terminal device can trigger at least one auxiliary terminal device to initiate the ranging request to the second terminal device.

In some embodiments, in response to a fact that the identification of the first terminal device is in the terminal device list, the privacy verification of the ranging request message passes.

In some embodiments, in response to a fact that both the identification of the first terminal device and the identification of the third terminal device are in the terminal device list, the privacy verification of the ranging request message passes.

In some embodiments, the second terminal device can also determine the number of auxiliary terminal devices triggered by the third terminal device. In response to a fact that the number of auxiliary terminal devices triggered by the third terminal device is less than or equal to the restriction information on the number of auxiliary terminal devices, the privacy verification of the ranging request message passes.

In some embodiments, in response to a fact that the identification of the first terminal device is in the terminal device list and all ranging information is in compliance with the restriction information in the privacy profile, the privacy verification of the ranging request message passes.

In step 203, a ranging response message is sent to the first terminal device, and the ranging response message is used to determine whether to accept the ranging request.

In some embodiments of the present disclosure, the second terminal device can send a ranging response message to the first terminal device after the privacy verification is performed on the ranging request message sent by the first terminal device. The ranging response message is used to determine whether to accept the ranging request. The first terminal device can determine, based on the ranging response message, whether the ranging request is allowed or rejected.

In some embodiments, in response to a fact that the privacy verification of the ranging request message fails, the ranging response message is used to reject the ranging request from the first terminal device.

It can be understood that in some embodiments, in response to a fact that the privacy verification of the ranging request message passes, the ranging response message is used to determine that the ranging request from the first terminal device is accepted. The second terminal device accepts the ranging request and continues the ranging task.

In some embodiments, in response to a fact that the ranging response message is used to reject the ranging request from the first terminal device, the ranging response message further includes a reason for rejecting the ranging request.

According to embodiments of the present disclosure, the ranging request message sent by the first terminal device is received, the privacy verification is performed on the ranging request message based on the privacy profile stored on the second terminal device, and the ranging response message is sent to the first terminal device, with the ranging response message being used to determine whether to accept the ranging request, so that the first terminal device needs to pass the privacy verification performed by the second terminal device and obtain permission from the second terminal device before performing the ranging service, to obtain the distance and the direction of the second terminal device to be ranged, effectively protecting the privacy of the terminal device from being leaked, and improving the security of the system.

As shown in FIG. 3, a schematic flowchart of a ranging method according to embodiments of the present disclosure is provided. It should be noted that the ranging method in some embodiments of the present disclosure is performed by a terminal device. The method can be performed independently or in combination with any other embodiment of the present disclosure. As shown in FIG. 3, the method can include the following steps.

In step 301, a ranging request message sent by a first terminal device is received.

In some embodiments of the present disclosure, the second terminal device can receive the ranging request message sent by the first terminal device, to receive the ranging request initiated by the first terminal device, and perform privacy verification of the ranging request message, to determine whether to allow the first terminal device to perform the ranging service.

In some embodiments of the present disclosure, the secure direct connection between the first terminal device and the second terminal device is established based on the ProSe procedure.

In some embodiments, the ranging request message includes identification of the first terminal device, identification of the second terminal device, and a ranging type.

In some embodiments, the ranging type can be directly ranging, meaning that the first terminal device directly initiates the ranging request, alternatively, the ranging type can be the ranging triggered by a third terminal device, meaning that the first terminal device initiates the ranging request under the trigger of the third terminal device.

In some embodiments, in the case where the ranging type is the ranging request initiated by the first terminal device under the trigger of the third terminal device, the ranging request message further includes identification of the third terminal device.

In some embodiments, the ranging request message further includes ranging information, and the ranging information includes at least one of the following: ranging geographic area information, ranging time period information, ranging distance accuracy information, or ranging direction accuracy information.

The ranging geographic area information refers to the geographic area where the ranging task requested by the first terminal device is to be performed.

The ranging time period information refers to the time period during which the ranging task requested by the first terminal device is to be performed.

The ranging distance accuracy information refers to the ranging distance accuracy required for the ranging task requested by the first terminal device.

The ranging direction accuracy information refers to the ranging direction accuracy required for the ranging task requested by the first terminal device.

In step 302, integrity verification is performed on the ranging request message.

In some embodiments of the present disclosure, the second terminal device can perform integrity verification of the received ranging request message, to determine that the ranging request message has not been tampered with.

In some embodiments, in response to a fact that the integrity verification of the ranging request message fails, it indicates that the ranging request message has been tampered with, and the second terminal device rejects the ranging request from the first terminal device.

In some embodiments, in response to a fact that the integrity verification of the ranging request message passes, it indicates that the ranging request message has not been tampered with, and the second terminal device continues to perform the privacy verification of the ranging request message.

In step 303, privacy verification is performed on the ranging request message based on a privacy profile stored on the second terminal device.

In some embodiments, the second terminal device can securely store a privacy profile and perform, based on the privacy profile, privacy verification of the ranging request message sent by the first terminal device, to determine whether to allow the first terminal device to perform the ranging service.

It should be noted that in some embodiments of the present disclosure, the second terminal device can deliver the locally stored privacy profile from the application layer to the ProSe layer.

In some embodiments, the privacy profile includes at least one of the following information: a terminal device list, ranging type restriction information, ranging geographic area restriction information, ranging time period restriction information, ranging distance accuracy restriction information, ranging direction accuracy restriction information, or restriction information on number of auxiliary terminal devices.

The terminal device list is a list of trusted terminal devices allowed to be connected to the second terminal device. The terminal device list includes identification of at least one terminal device allowed to be connected to the second terminal device.

The ranging type restriction information refers to the ranging types supported by the second terminal device.

The ranging geographic area restriction information refers to the area allowed for the ranging to be performed on the second terminal device.

The ranging time period restriction information refers to the time period during which the ranging is allowed to be performed on the second terminal device.

The ranging distance accuracy restriction information refers to the highest distance accuracy allowed for the ranging to be performed on the second terminal device.

The ranging direction accuracy restriction information refers to the highest direction accuracy allowed for the ranging to be performed on the second terminal device.

The restriction information on number of auxiliary terminal devices refers to the maximum number of auxiliary terminal devices participating in the collaborative ranging procedure.

It should be noted that auxiliary terminal devices participate in the collaborative ranging procedure, and the more auxiliary terminal devices there are, the higher the accuracy of the final ranging result is. If the first terminal device initiates the ranging request under the trigger of the third terminal device, then the first terminal device is the auxiliary terminal device. The third terminal device can trigger at least one auxiliary terminal device to initiate the ranging request to the second terminal device.

In some embodiments, in response to a fact that the identification of the first terminal device is in the terminal device list, the privacy verification of the ranging request message passes. In some embodiments, in response to a fact that the identification of the first terminal device is not in the terminal device list, the privacy verification of the ranging request message fails.

In some embodiments, the ranging type of the ranging initiated by the first terminal device is the ranging triggered by the third terminal device, and the second terminal device needs to verify whether the first terminal device and the third terminal device are both in the terminal device list allowed for connections.

In response to a fact that the identification of the first terminal device and the identification of the third terminal device are both in the terminal device list, the privacy verification of the ranging request message passes. In response to a fact that the identification of the first terminal device and/or the identification of the third terminal device are/is not in the terminal device list, the privacy verification of the ranging request message fails. That is, the first terminal device and the third terminal device must be both in the terminal device list to enable the privacy verification of the ranging request message to be successful. If one of the first terminal device and the third terminal device is not in the terminal device list, the privacy verification of the ranging request message will fail.

In some embodiments, the ranging type of the ranging initiated by the first terminal device is the ranging triggered by the third terminal device, and the first terminal device is the auxiliary terminal device. The second terminal device can also determine the number of auxiliary terminal devices triggered by the third terminal device.

In response to a fact that the number of auxiliary terminal devices triggered by the third terminal device is less than or equal to the restriction information on the number of auxiliary terminal devices, the privacy verification of the ranging request message passes. In response to a fact that the number of auxiliary terminal devices triggered by the third terminal device is greater than the restriction information on the number of auxiliary terminal devices, the privacy verification of the ranging request message fails.

In some embodiments, in response to a fact that all ranging information is in compliance with the restriction information in the privacy profile, the privacy verification of the ranging request message passes. That is, the ranging information in the ranging request message must be all in compliance with the restriction information in the privacy profile to enable the privacy verification of the ranging request message to be successful. If one of the ranging information in the ranging request message is not in compliance with the restriction information in the privacy profile, the privacy verification of the ranging request message will fail.

It can be understood that in order to enable the privacy verification of the ranging request message to be successful, the identification of the first terminal device, the ranging type, and the ranging information, which are included in the ranging request message must be all in compliance with the restrictions in the privacy profile.

If the ranging type of the ranging request is the ranging triggered by the third terminal device, in order to enable the privacy verification of the ranging request message to be successful, the identification of the first terminal device, the identification of the third terminal device, the ranging type, and the ranging information, which are included in the ranging request message must be all in compliance with the restrictions in the privacy profile, and the number of auxiliary terminal devices triggered by the third terminal device is less than or equal to the restriction information on the number of auxiliary terminal devices.

In step 304, a ranging response message is sent to the first terminal device, and the ranging response message is used to determine whether to accept the ranging request.

In some embodiments, the second terminal device can send a ranging response message to the first terminal device after the privacy verification is performed on the ranging request message sent by the first terminal device. The ranging response message is used to determine whether to accept the ranging request. The first terminal device can determine, based on the ranging response message, whether the ranging request is allowed or rejected.

In some embodiments, in response to a fact that the privacy verification of the ranging request message fails, the ranging response message is used to reject the ranging request from the first terminal device.

It can be understood that in some embodiments, in response to a fact that the privacy verification of the ranging request message passes, the ranging response message is used to determine that the ranging request from the first terminal device is accepted. The second terminal device accepts the ranging request and continues the ranging task.

In some embodiments, in response to a fact that the ranging response message is used to reject the ranging request from the first terminal device, the ranging response message further includes a reason for rejecting the ranging request.

According to embodiments of the present disclosure, the ranging request message sent by the first terminal device is received, the integrity of the ranging request message is verified, the privacy verification is performed on the ranging request message based on the privacy profile stored on the second terminal device, and the ranging response message is sent to the first terminal device, with the ranging response message being used to determine whether to accept the ranging request, so that the first terminal device needs to pass the privacy verification performed by the second terminal device and obtain permission from the second terminal device before performing the ranging service, to obtain the distance and the direction of the second terminal device to be ranged, effectively protecting the privacy of the terminal device from being leaked, and improving the security of the system.

As shown in FIG. 4, a schematic flowchart of a ranging method according to embodiments of the present disclosure is provided. It should be noted that the ranging method in some embodiments of the present disclosure is performed by a first terminal device. The method can be performed independently or in combination with any other embodiment of the present disclosure. As shown in FIG. 4, the method can include the following steps.

In step 401, a ranging request message is sent to a second terminal device, and the ranging request message is used to request for ranging to be performed on the second terminal device.

In some embodiments of the present disclosure, the first terminal device can send a ranging request message to the second terminal device, and the second terminal device can receive the ranging request initiated by the first terminal device and perform privacy verification of the ranging request message, to determine whether to allow the first terminal device to perform the ranging service.

It can be understood that in some embodiments of the present disclosure, the ranging request message sent by the first terminal device to the second terminal device is used to request for ranging to be performed on the second terminal device. The second terminal device can perform the privacy verification of the ranging request message based on the privacy profile stored on the second terminal device, meaning that the ranging request message can also be used for the privacy verification by the second terminal device.

In some embodiments of the present disclosure, the secure direct connection between the first terminal device and the second terminal device is established based on the ProSe procedure.

In some embodiments, the ranging request message includes identification of the first terminal device, identification of the second terminal device, and a ranging type.

In some embodiments, the ranging type can be directly ranging, meaning that the first terminal device directly initiates the ranging request, alternatively, the ranging type can be the ranging triggered by a third terminal device, meaning that the first terminal device initiates the ranging request under the trigger of the third terminal device.

In some embodiments, in the case where the ranging type is the ranging request initiated by the first terminal device under the trigger of the third terminal device, the ranging request message further includes identification of the third terminal device.

In some embodiments, the ranging request message further includes ranging information, and the ranging information includes at least one of the following: ranging geographic area information, ranging time period information, ranging distance accuracy information, or ranging direction accuracy information.

The ranging geographic area information refers to the geographic area where the ranging task requested by the first terminal device is to be performed.

The ranging time period information refers to the time period during which the ranging task requested by the first terminal device is to be performed.

The ranging distance accuracy information refers to the ranging distance accuracy required for the ranging task requested by the first terminal device.

The ranging direction accuracy information refers to the ranging direction accuracy required for the ranging task requested by the first terminal device.

In step 402, a ranging response message sent by the second terminal device is received, and the ranging response message is used to determine whether to accept the ranging request.

In some embodiments of the present disclosure, the first terminal device can receive the ranging response message sent by the second terminal device. The ranging response message is used to determine whether to accept the ranging request. The first terminal device can determine, based on the ranging response message, whether the ranging request is allowed or rejected.

In some embodiments, in response to a fact that the privacy verification of the ranging request message fails, the ranging response message is used to reject the ranging request from the first terminal device.

It can be understood that in some embodiments, in response to a fact that the privacy verification of the ranging request message passes, the ranging response message is used to determine that the ranging request from the first terminal device is accepted. The second terminal device accepts the ranging request and continues the ranging task.

In some embodiments, the first terminal device can also perform integrity verification of the received ranging response message, and verify whether the response message has been tampered with. If the integrity verification fails, it indicates that the ranging response message has been tampered with, and the first terminal device can reject the ranging response message.

In some embodiments, in response to a fact that the ranging response message is used to reject the ranging request from the first terminal device, the ranging response message further includes a reason for rejecting the ranging request.

According to embodiments of the present disclosure, the ranging request message is sent to the second terminal device, with the ranging request message being used to request for ranging to be performed on the second terminal device, and the ranging response message sent by the second terminal device is received, with the ranging response message being used to determine whether to accept the ranging request, so that the first terminal device needs to pass the privacy verification performed by the second terminal device and obtain permission from the second terminal device before performing the ranging service, to obtain the distance and the direction of the second terminal device to be ranged, effectively protecting the privacy of the terminal device from being leaked, and improving the security of the system.

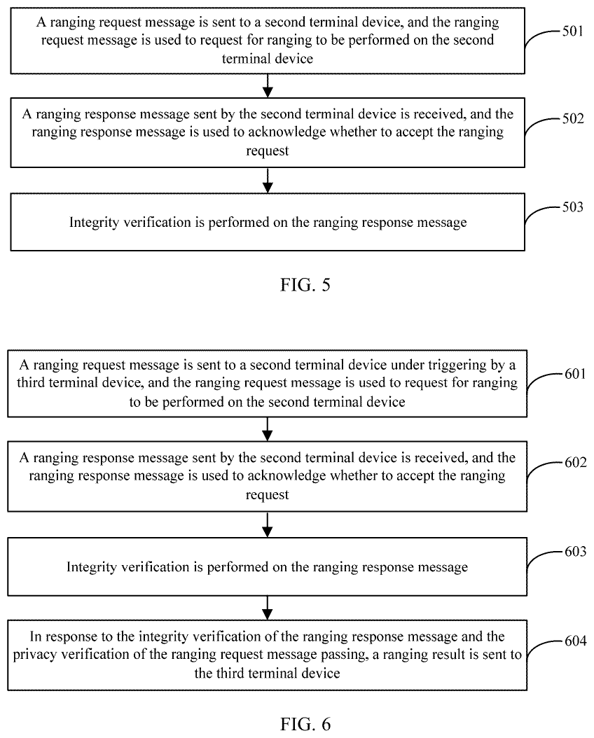

As shown in FIG. 5, a schematic flowchart of a ranging method according to embodiments of the present disclosure is provided. It should be noted that the ranging method in some embodiments of the present disclosure is performed by a first terminal device. The method can be performed independently or in combination with any other embodiment of the present disclosure. As shown in FIG. 5, the method can include the following steps.

In step 501, a ranging request message is sent to a second terminal device, and the ranging request message is used to request for ranging to be performed on the second terminal device.

In some embodiments of the present disclosure, the first terminal device can send a ranging request message to the second terminal device, and the second terminal device can receive the ranging request initiated by the first terminal device and perform privacy verification of the ranging request message, to determine whether to allow the first terminal device to perform the ranging service.

In some embodiments of the present disclosure, the secure direct connection between the first terminal device and the second terminal device is established based on the ProSe procedure.

It can be understood that in some embodiments of the present disclosure, the ranging request message sent by the first terminal device to the second terminal device is used to request for ranging to be performed on the second terminal device. The second terminal device can perform the privacy verification of the ranging request message based on the privacy profile stored on the second terminal device, meaning that the ranging request message can also be used for the privacy verification by the second terminal device.

In some embodiments, the ranging request message includes identification of the first terminal device, identification of the second terminal device, and a ranging type.

In some embodiments, the ranging type can be directly ranging, meaning that the first terminal device directly initiates the ranging request, alternatively, the ranging type can be the ranging triggered by a third terminal device, meaning that the first terminal device initiates the ranging request under the trigger of the third terminal device.

In some embodiments, in the case where the ranging type is the ranging request initiated by the first terminal device under the trigger of the third terminal device, the ranging request message further includes identification of the third terminal device.

In some embodiments, the ranging request message further includes ranging information, and the ranging information includes at least one of the following: ranging geographic area information, ranging time period information, ranging distance accuracy information, or ranging direction accuracy information.

The ranging geographic area information refers to the geographic area where the ranging task requested by the first terminal device is to be performed.

The ranging time period information refers to the time period during which the ranging task requested by the first terminal device is to be performed.

The ranging distance accuracy information refers to the ranging distance accuracy required for the ranging task requested by the first terminal device.

The ranging direction accuracy information refers to the ranging direction accuracy required for the ranging task requested by the first terminal device.

In some embodiments of the present disclosure, the second terminal device can perform the privacy verification of the ranging request message based on the privacy profile stored on the second terminal device, and obtain a result of the privacy verification performed on the ranging request message.

In step 502, a ranging response message sent by the second terminal device is received, and the ranging response message is used to determine whether to accept the ranging request.

In some embodiments of the present disclosure, the first terminal device can receive the ranging response message sent by the second terminal device. The ranging response message is used to determine whether to accept the ranging request. The first terminal device can determine, based on the ranging response message, whether the ranging request is allowed or rejected.

In some embodiments, in response to a fact that the privacy verification of the ranging request message fails, the ranging response message is used to reject the ranging request from the first terminal device.

It can be understood that in some embodiments, in response to a fact that the privacy verification of the ranging request message passes, the ranging response message is used to determine that the ranging request from the first terminal device is accepted. The second terminal device accepts the ranging request and continues the ranging task.

In step 503, integrity verification is performed on the ranging response message.

In some embodiments of the present disclosure, the first terminal device can perform integrity verification of the received ranging response message, to determine that the ranging response message has not been tampered with.

In some embodiments, in response to a fact that the integrity verification of the ranging response message fails, it indicates that the ranging response message has been tampered with, and the first terminal device can reject the ranging response message.

In some embodiments, in response to a fact that the integrity verification of the ranging response message passes, it indicates that the ranging response message has not been tampered with, and the first terminal device receives and parses the ranging response message.

According to embodiments of the present disclosure, the ranging request message is sent to the second terminal device, with the ranging request message being used to request for ranging to be performed on the second terminal device, and the ranging response message sent by the second terminal device is received, with the ranging response message being used to determine whether to accept the ranging request. The integrity of the ranging response message is verified, so that the first terminal device needs to pass the privacy verification performed by the second terminal device and obtain permission from the second terminal device before performing the ranging service, to obtain the distance and the direction of the second terminal device to be ranged, effectively protecting the privacy of the terminal device from being leaked, and improving the security of the system.

As shown in FIG. 6, a schematic flowchart of a ranging method according to embodiments of the present disclosure is provided. It should be noted that the ranging method in some embodiments of the present disclosure is performed by a first terminal device. The method can be performed independently or in combination with any other embodiment of the present disclosure. As shown in FIG. 6, the method can include the following steps.

In step 601, a ranging request message is sent to a second terminal device under trigger of a third terminal device, and the ranging request message is used to request for ranging to be performed on the second terminal device.

In some embodiments of the present disclosure, the first terminal device sends the ranging request message to the second terminal device under the trigger of the third terminal device. The second terminal device can receive the ranging request initiated by the first terminal device and perform privacy verification of the ranging request message, to determine whether to allow the first terminal device to perform the ranging service.

In some embodiments of the present disclosure, the secure direct connection between the first terminal device and the second terminal device is established based on the ProSe procedure.

It can be understood that in some embodiments of the present disclosure, the ranging request message sent by the first terminal device to the second terminal device is used to request for ranging to be performed on the second terminal device. The second terminal device can perform the privacy verification of the ranging request message based on the privacy profile stored on the second terminal device, meaning that the ranging request message can also be used for the privacy verification by the second terminal device.

In some embodiments, the first terminal device can receive indication information sent by the third terminal device, and the indication information is configured to indicate to the first terminal device to initiate a ranging request to the second terminal device.

It can be understood that in some embodiments of the present disclosure, the first terminal device initiates the ranging request to the second terminal device under the trigger of the third terminal device. Therefore, the first terminal device is an auxiliary terminal device, and the first terminal device is the auxiliary terminal device serving the third terminal device. The third terminal device can trigger at least one terminal device to initiate the ranging request to the second terminal device, and the at least one terminal device being triggered is at least one auxiliary terminal device serving the third terminal device.

In some embodiments, the ranging request message includes identification of the first terminal device, identification of the second terminal device, identification of the third terminal device, and a ranging type.

In some embodiments of the present disclosure, the ranging type is ranging triggered by the third terminal device, meaning that the first terminal device initiates the ranging request under the trigger of the third terminal device.

In some embodiments, the ranging request message further includes ranging information, and the ranging information includes at least one of the following: ranging geographic area information, ranging time period information, ranging distance accuracy information, or ranging direction accuracy information.

The ranging geographic area information refers to the geographic area where the ranging task requested by the first terminal device is to be performed.

The ranging time period information refers to the time period during which the ranging task requested by the first terminal device is to be performed.

The ranging distance accuracy information refers to the ranging distance accuracy required for the ranging task requested by the first terminal device.

The ranging direction accuracy information refers to the ranging direction accuracy required for the ranging task requested by the first terminal device.

In some embodiments of the present disclosure, the second terminal device can perform the privacy verification of the ranging request message based on the privacy profile stored on the second terminal device, and obtain a result of the privacy verification performed on the ranging request message.

In step 602, a ranging response message sent by the second terminal device is received, and the ranging response message is used to determine whether to accept the ranging request.

In some embodiments of the present disclosure, the first terminal device can receive the ranging response message sent by the second terminal device. The ranging response message is used to determine whether to accept the ranging request. The first terminal device can determine, based on the ranging response message, whether the ranging request is allowed or rejected.

In some embodiments, in response to a fact that the privacy verification of the ranging request message fails, the ranging response message is used to reject the ranging request from the first terminal device.

It can be understood that in some embodiments, in response to a fact that the privacy verification of the ranging request message passes, the ranging response message is used to determine that the ranging request from the first terminal device is accepted. The second terminal device accepts the ranging request and continues the ranging task.

It can be understood that in some embodiments of the present disclosure, the second terminal device can verify whether the ranging triggered by the third terminal device is supported, and verify whether the identification of the first terminal device and the identification of the third terminal device are both in the terminal device list in the privacy profile, and verify whether the number of auxiliary terminal devices triggered by the third terminal device is less than or equal to the restriction information on the number of auxiliary terminal devices, and verify whether the ranging information included in the ranging request message is all in compliance with the restrictions in the privacy profile. If all verifications are successful, then the privacy verification of the ranging request message passes.

In step 603, integrity verification is performed on the ranging response message.

In some embodiments of the present disclosure, the first terminal device can perform integrity verification of the received ranging response message, to determine that the ranging response message has not been tampered with.

In some embodiments, in response to a fact that the integrity verification of the ranging response message fails, it indicates that the ranging response message has been tampered with, and the first terminal device can reject the ranging response message.

In some embodiments, in response to a fact that the integrity verification of the ranging response message passes, it indicates that the ranging response message has not been tampered with, and the first terminal device receives and parses the ranging response message.

In step 604, in response to the integrity verification of the ranging response message and the privacy verification of the ranging request message passing, a ranging result is sent to the third terminal device.

In some embodiments of the present disclosure, if the integrity verification of the ranging response message passes, it indicates that the ranging response message has not been tampered with. The first terminal device receives and parses the ranging response message. If the privacy verification of the ranging request message also passes, the first terminal device then can perform the ranging service. The first terminal device can send the ranging result to the third terminal device, which is obtained from performing of the ranging service. In some embodiments, the first terminal device serves as an auxiliary terminal device serving the third terminal device and sends the ranging result to the third terminal device obtained from ranging.

According to embodiments of the present disclosure, the ranging request message is sent to the second terminal device under the trigger of the third terminal device, with the ranging request message being used to request for ranging to be performed on the second terminal device, and the ranging response message sent by the second terminal device is received, with the ranging response message being used to determine whether to accept the ranging request. The integrity of the ranging response message is verified, and in response to a fact that the integrity verification of the ranging response message and the privacy verification of the ranging request message pass, the ranging result is sent to the third terminal device, so that the first terminal device needs to pass the privacy verification performed by the second terminal device and obtain permission from the second terminal device before performing the ranging service, to obtain the distance and the direction of the second terminal device to be ranged, effectively protecting the privacy of the terminal device from being leaked, and improving the security of the system.

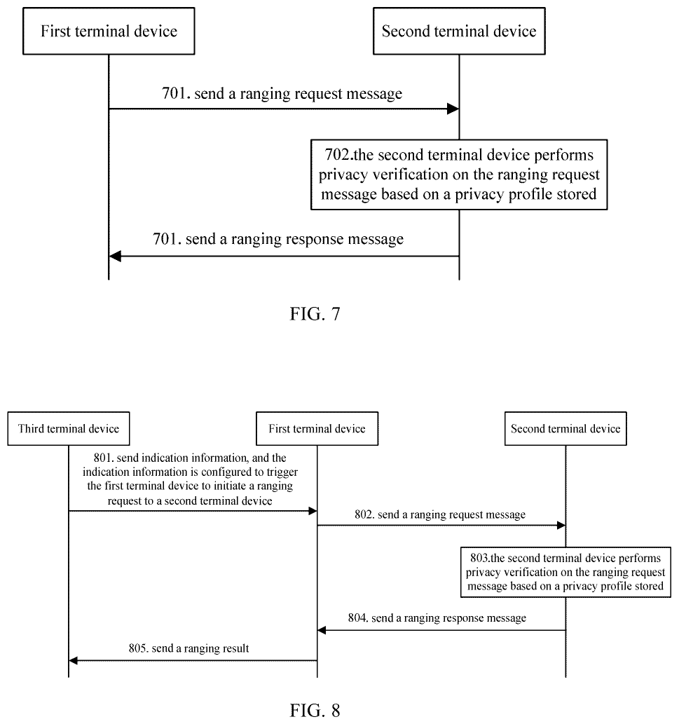

As shown in FIG. 7, a schematic flowchart of a ranging method according to embodiments of the present disclosure is provided. The method can be performed independently or in combination with any other embodiment of the present disclosure. As shown in FIG. 7, the method can include the following steps.

In step 701, the first terminal device sends a ranging request message to a second terminal device.

In some embodiments of the present disclosure, the secure direct connection between the first terminal device and the second terminal device is established based on the ProSe procedure.

It can be understood that in some embodiments of the present disclosure, the ranging request message sent by the first terminal device to the second terminal device is used to request for ranging to be performed on the second terminal device. The second terminal device can perform the privacy verification of the ranging request message based on the privacy profile stored on the second terminal device.

In some embodiments, the ranging request message includes identification of the first terminal device, identification of the second terminal device, and a ranging type.

In some embodiments, the ranging type can be directly ranging, meaning that the first terminal device directly initiates the ranging request, alternatively, the ranging type can be the ranging triggered by a third terminal device, meaning that the first terminal device initiates the ranging request under the trigger of the third terminal device.

In some embodiments, in the case where the ranging type is the ranging request initiated by the first terminal device under the trigger of the third terminal device, the ranging request message further includes identification of the third terminal device.

In some embodiments, the ranging request message further includes ranging information, and the ranging information includes at least one of the following: ranging geographic area information, ranging time period information, ranging distance accuracy information, or ranging direction accuracy information.

The ranging geographic area information refers to the geographic area where the ranging task requested by the first terminal device is to be performed.

The ranging time period information refers to the time period during which the ranging task requested by the first terminal device is to be performed.

The ranging distance accuracy information refers to the ranging distance accuracy required for the ranging task requested by the first terminal device.

The ranging direction accuracy information refers to the ranging direction accuracy required for the ranging task requested by the first terminal device.

In some embodiments of the present disclosure, the second terminal device can perform the privacy verification of the ranging request message based on the privacy profile stored on the second terminal device, and obtain a result of the privacy verification performed on the ranging request message.

In step 702, the second terminal device performs privacy verification of the ranging request message based on a privacy profile stored.

In some embodiments of the present disclosure, the second terminal device can deliver the locally stored privacy profile from the application layer to the ProSe layer.

In some embodiments, the privacy profile includes at least one of the following information: a terminal device list, ranging type restriction information, ranging geographic area restriction information, ranging time period restriction information, ranging distance accuracy restriction information, ranging direction accuracy restriction information, or restriction information on number of auxiliary terminal devices.

The terminal device list is a list of trusted terminal devices allowed to be connected to the second terminal device. The terminal device list includes identification of at least one terminal device allowed to be connected to the second terminal device.

The ranging type restriction information refers to the ranging types supported by the second terminal device.

The ranging geographic area restriction information refers to the area allowed for the ranging to be performed on the second terminal device.

The ranging time period restriction information refers to the time period during which the ranging is allowed to be performed on the second terminal device.

The ranging distance accuracy restriction information refers to the highest distance accuracy allowed for the ranging to be performed on the second terminal device.

The ranging direction accuracy restriction information refers to the highest direction accuracy allowed for the ranging to be performed on the second terminal device.

The restriction information on number of auxiliary terminal devices refers to the maximum number of auxiliary terminal devices participating in the collaborative ranging procedure.

It should be noted that auxiliary terminal devices participate in the collaborative ranging procedure, and the more auxiliary terminal devices there are, the higher the accuracy of the final ranging result is. If the first terminal device initiates the ranging request under the trigger of the third terminal device, then the first terminal device is the auxiliary terminal device. The third terminal device can trigger at least one auxiliary terminal device to initiate the ranging request to the second terminal device.

In some embodiments, in response to a fact that the identification of the first terminal device is in the terminal device list, the privacy verification of the ranging request message passes. In some embodiments, in response to a fact that the identification of the first terminal device is not in the terminal device list, the privacy verification of the ranging request message fails.

In some embodiments, the ranging type of the ranging initiated by the first terminal device is the ranging triggered by the third terminal device, and the second terminal device needs to verify whether the first terminal device and the third terminal device are both in the terminal device list allowed for connections.

In response to a fact that the identification of the first terminal device and the identification of the third terminal device are both in the terminal device list, the privacy verification of the ranging request message passes. In response to a fact that the identification of the first terminal device and/or the identification of the third terminal device are/is not in the terminal device list, the privacy verification of the ranging request message fails. That is, the first terminal device and the third terminal device must be both in the terminal device list to enable the privacy verification of the ranging request message to be successful. If one of the first terminal device and the third terminal device is not in the terminal device list, the privacy verification of the ranging request message will fail.

In some embodiments, the ranging type of the ranging initiated by the first terminal device is the ranging triggered by the third terminal device, and the first terminal device is the auxiliary terminal device. The second terminal device can also determine the number of auxiliary terminal devices triggered by the third terminal device.

In response to a fact that the number of auxiliary terminal devices triggered by the third terminal device is less than or equal to the restriction information on the number of auxiliary terminal devices, the privacy verification of the ranging request message passes. In response to a fact that the number of auxiliary terminal devices triggered by the third terminal device is greater than the restriction information on the number of auxiliary terminal devices, the privacy verification of the ranging request message fails.

In some embodiments, in response to a fact that all ranging information is in compliance with the restriction information in the privacy profile, the privacy verification of the ranging request message passes. That is, the ranging information in the ranging request message must be all in compliance with the restriction information in the privacy profile to enable the privacy verification of the ranging request message to be successful. If one of the ranging information in the ranging request message is not in compliance with the restriction information in the privacy profile, the privacy verification of the ranging request message will fail.

It can be understood that in order to enable the privacy verification of the ranging request message to be successful, the identification of the first terminal device, the ranging type, and the ranging information, which are included in the ranging request message must be all in compliance with the restrictions in the privacy profile.

If the ranging type of the ranging request is the ranging triggered by the third terminal device, in order to enable the privacy verification of the ranging request message to be successful, the identification of the first terminal device, the identification of the third terminal device, the ranging type, and the ranging information, which are included in the ranging request message must be all in compliance with the restrictions in the privacy profile, and the number of auxiliary terminal devices triggered by the third terminal device is less than or equal to the restriction information on the number of auxiliary terminal devices.

In step 703, the second terminal device sends a ranging response message to the first terminal device.

In some embodiments, the second terminal device can send a ranging response message to the first terminal device after the privacy verification is performed on the ranging request message sent by the first terminal device. The ranging response message is used to determine whether to accept the ranging request. The first terminal device can determine, based on the ranging response message, whether the ranging request is allowed or rejected.

In some embodiments, in response to a fact that the privacy verification of the ranging request message fails, the ranging response message is used to reject the ranging request from the first terminal device.

It can be understood that in some embodiments, in response to a fact that the privacy verification of the ranging request message passes, the ranging response message is used to determine that the ranging request from the first terminal device is accepted. The second terminal device accepts the ranging request and continues the ranging task.

According to embodiments of the present disclosure, the first terminal device sends the ranging request message to the second terminal device. The second terminal device performs the privacy verification of the ranging request message based on the stored privacy profile. The second terminal device then sends the ranging response message to the first terminal device, so that the first terminal device needs to pass the privacy verification performed by the second terminal device and obtain permission from the second terminal device before performing the ranging service, to obtain the distance and the direction of the second terminal device to be ranged, effectively protecting the privacy of the terminal device from being leaked, and improving the security of the system.

As shown in FIG. 8, a schematic flowchart of a ranging method according to embodiments of the present disclosure is provided. The method can be performed independently or in combination with any other embodiment of the present disclosure. As shown in FIG. 8, the method can include the following steps.

In step 801, a third terminal device sends indication information to a first terminal device, and the indication information is configured to trigger the first terminal device to initiate a ranging request to a second terminal device.

It should be noted that in some embodiments of the present disclosure, the secure direct connection between the third terminal device and the first terminal device, as well as the secure direct connection between the first terminal device and the second terminal device, can both be established based on the ProSe procedure.

In some embodiments of the present disclosure, the third terminal device can trigger the first terminal device to initiate the ranging request to the second terminal device. In some embodiments, the first terminal device can receive the indication information sent by the third terminal device, and the indication information is configured to indicate to the first terminal device to initiate the ranging request to the second terminal device.

In some embodiments, the indication information can include identification of the second terminal device.

It can be understood that in some embodiments of the present disclosure, the first terminal device initiates the ranging request to the second terminal device under the trigger of the third terminal device. Therefore, the first terminal device is an auxiliary terminal device, and the first terminal device is the auxiliary terminal device serving the third terminal device. The third terminal device can trigger at least one terminal device to initiate the ranging request to the second terminal device, and the at least one terminal device being triggered is at least one auxiliary terminal device serving the third terminal device.

In step 802, the first terminal device sends a ranging request message to the second terminal device under trigger of the third terminal device.

In some embodiments of the present disclosure, the first terminal device initiates the ranging request to the second terminal device under the trigger of the third terminal device. The ranging request message includes identification of the first terminal device, identification of the second terminal device, identification of the third terminal device, and a ranging type.

In some embodiments of the present disclosure, the ranging type is ranging triggered by the third terminal device, meaning that the first terminal device initiates the ranging request under the trigger of the third terminal device.

In some embodiments, the ranging request message further includes ranging information, and the ranging information includes at least one of the following: ranging geographic area information, ranging time period information, ranging distance accuracy information, or ranging direction accuracy information.

The ranging geographic area information refers to the geographic area where the ranging task requested by the first terminal device is to be performed.

The ranging time period information refers to the time period during which the ranging task requested by the first terminal device is to be performed.

The ranging distance accuracy information refers to the ranging distance accuracy required for the ranging task requested by the first terminal device.

The ranging direction accuracy information refers to the ranging direction accuracy required for the ranging task requested by the first terminal device.

In some embodiments of the present disclosure, the second terminal device can perform the privacy verification of the ranging request message based on the privacy profile stored on the second terminal device, and obtain a result of the privacy verification performed on the ranging request message.

In step 803, the second terminal device performs privacy verification of the ranging request message based on a privacy profile stored.

In some embodiments of the present disclosure, the second terminal device can deliver the locally stored privacy profile from the application layer to the ProSe layer.

In some embodiments, the privacy profile includes at least one of the following information: a terminal device list, ranging type restriction information, ranging geographic area restriction information, ranging time period restriction information, ranging distance accuracy restriction information, ranging direction accuracy restriction information, or restriction information on number of auxiliary terminal devices.

The terminal device list is a list of trusted terminal devices allowed to be connected to the second terminal device. The terminal device list includes identification of at least one terminal device allowed to be connected to the second terminal device.

The ranging type restriction information refers to the ranging types supported by the second terminal device.

The ranging geographic area restriction information refers to the area allowed for the ranging to be performed on the second terminal device.

The ranging time period restriction information refers to the time period during which the ranging is allowed to be performed on the second terminal device.

The ranging distance accuracy restriction information refers to the highest distance accuracy allowed for the ranging to be performed on the second terminal device.

The ranging direction accuracy restriction information refers to the highest direction accuracy allowed for the ranging to be performed on the second terminal device.

The restriction information on number of auxiliary terminal devices refers to the maximum number of auxiliary terminal devices participating in the collaborative ranging procedure.

It should be noted that auxiliary terminal devices participate in the collaborative ranging procedure, and the more auxiliary terminal devices there are, the higher the accuracy of the final ranging result is. In some embodiments, if the first terminal device initiates the ranging request under the trigger of the third terminal device, then the first terminal device is the auxiliary terminal device. The third terminal device can trigger at least one auxiliary terminal device to initiate the ranging request to the second terminal device.

In some embodiments, the second terminal device can perform the integrity verification of the ranging request message received. In response to a fact that the integrity verification of the ranging request message passes, the second terminal device performs the privacy verification of the ranging request message based on the privacy profile stored.

In response to a fact that the integrity verification of the ranging request message fails, the second terminal device rejects the ranging request, meaning that the ranging response message sent by the second terminal device to the first terminal device is used to reject the ranging request.

In some embodiments of the present disclosure, the second terminal device needs to verify whether the first terminal device and the third terminal device are both in the terminal device list allowed for connections.

In response to a fact that the identification of the first terminal device and the identification of the third terminal device are both in the terminal device list, the privacy verification of the ranging request message passes. In response to a fact that the identification of the first terminal device and/or the identification of the third terminal device are/is not in the terminal device list, the privacy verification of the ranging request message fails. That is, the first terminal device and the third terminal device must be both in the terminal device list to enable the privacy verification of the ranging request message to be successful. If one of the first terminal device and the third terminal device is not in the terminal device list, the privacy verification of the ranging request message will fail.

In some embodiments of the present disclosure, the second terminal device can also determine the number of auxiliary terminal devices triggered by the third terminal device.

In response to a fact that the number of auxiliary terminal devices triggered by the third terminal device is less than or equal to the restriction information on the number of auxiliary terminal devices, the privacy verification of the ranging request message passes. In response to a fact that the number of auxiliary terminal devices triggered by the third terminal device is greater than the restriction information on the number of auxiliary terminal devices, the privacy verification of the ranging request message fails.

In some embodiments, in response to a fact that all ranging information is in compliance with the restriction information in the privacy profile, the privacy verification of the ranging request message passes. That is, the ranging information in the ranging request message must be all in compliance with the restriction information in the privacy profile to enable the privacy verification of the ranging request message to be successful. If one of the ranging information in the ranging request message is not in compliance with the restriction information in the privacy profile, the privacy verification of the ranging request message will fail.

It can be understood that in some embodiments of the present disclosure, in order to enable the privacy verification of the ranging request message to be successful, the identification of the first terminal device, the identification of the third terminal device, the ranging type, and the ranging information, which are included in the ranging request message must be all in compliance with the restrictions in the privacy profile, and the number of auxiliary terminal devices triggered by the third terminal device must be less than or equal to the restriction information on the number of auxiliary terminal devices.

In step 804, the second terminal device sends a ranging response message to the first terminal device.

In some embodiments, the second terminal device can send a ranging response message to the first terminal device after the privacy verification is performed on the ranging request message sent by the first terminal device. The ranging response message is used to determine whether to accept the ranging request. The first terminal device can determine, based on the ranging response message, whether the ranging request is allowed or rejected.

In some embodiments, in response to a fact that the privacy verification of the ranging request message fails, the ranging response message is used to reject the ranging request from the first terminal device.

It can be understood that in some embodiments, in response to a fact that the privacy verification of the ranging request message passes, the ranging response message is used to determine that the ranging request from the first terminal device is accepted. The second terminal device accepts the ranging request and continues the ranging task.

In some embodiments, in response to a fact that the ranging response message is used to reject the ranging request from the first terminal device, the ranging response message further includes a reason for rejecting the ranging request.

In step 805, the first terminal device sends a ranging result to the third terminal device.

In some embodiments, the first terminal device can perform integrity verification of the ranging response message sent by the second terminal device.

In some embodiments, in response to a fact that the integrity verification of the ranging response message fails, it indicates that the ranging response message has been tampered with, and the first terminal device can reject the ranging response message.

In some embodiments, in response to a fact that the integrity verification of the ranging response message passes, it indicates that the ranging response message has not been tampered with, and the first terminal device receives and parses the ranging response message.

In some embodiments of the present disclosure, if the integrity verification of the ranging response message passes, it indicates that the ranging response message has not been tampered with. The first terminal device receives and parses the ranging response message. If the privacy verification of the ranging request message also passes, the first terminal device then can perform the ranging service. The first terminal device can send the ranging result to the third terminal device, which is obtained from performing of the ranging service. In some embodiments, the first terminal device serves as an auxiliary terminal device serving the third terminal device and sends the ranging result to the third terminal device obtained from ranging.

According to embodiments of the present disclosure, the third terminal device sends the indication information to the first terminal device, and the indication information is used to trigger the first terminal device to initiate the ranging request to the second terminal device. The first terminal device sends the ranging request message to the second terminal device under the trigger of the third terminal device. The second terminal device performs the privacy verification of the ranging request message based on the stored privacy profile. The second terminal device sends the ranging response message to the first terminal device, and the first terminal device sends the ranging result to the third terminal device, so that the first terminal device needs to pass the privacy verification of the second terminal device and obtain the permission of the second terminal device before it can execute the ranging service, obtain the distance and direction of the second terminal device being measured, and effectively protect the terminal device. Privacy is not leaked, Improve the security of the system.

Embodiments of the present disclosure also provide a ranging apparatus corresponding to the ranging methods in the above embodiments. The ranging apparatus provided embodiments of the present disclosure correspond to the methods provided in the above embodiments, and thus the implementations of the ranging methods are also applicable to the ranging apparatus in the following embodiments, which will not be described in detail in the following.

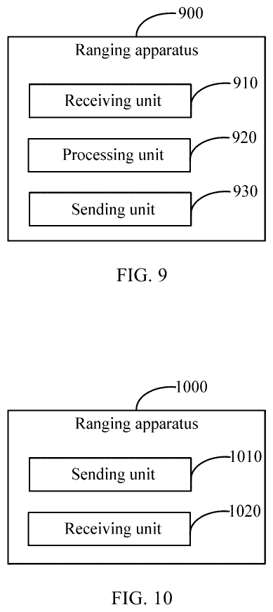

As shown in FIG. 9, a schematic diagram of a structure of a ranging apparatus according to embodiments of the present disclosure is provided.

As shown in FIG. 9, the ranging apparatus 900 includes a receiving unit 910, a processing unit 920, and a sending unit 930.

The receiving unit 910 is configured to receive a ranging request message sent by a first terminal device

The processing unit 920 is configured to perform privacy verification of the ranging request message based on a privacy profile stored on the second terminal device.

The sending unit 930 is configured to send a ranging response message to the first terminal device. The ranging response message is used to determine whether to accept a ranging request.

In some embodiments, the privacy profile includes at least one of following information:
a terminal device list including identification of at least one terminal device allowed to be connected to the second terminal device;
ranging type restriction information;
ranging geographic area restriction information;
ranging time period restriction information;
ranging distance accuracy restriction information;
ranging direction accuracy restriction information; or
restriction information on number of auxiliary terminal devices.

In some embodiments, the ranging request message includes identification of the first terminal device, identification of the second terminal device, and a ranging type, and the ranging type includes the ranging request directly initiated by the first terminal device, or the ranging request initiated by the first terminal device under trigger of a third terminal device.

In some embodiments, in response to the ranging type being the ranging request initiated by the first terminal device under the trigger of the third terminal device, the ranging request message further includes identification of the third terminal device.

In some embodiments, the ranging request message further includes ranging information, and the ranging information includes at least one of the following: ranging geographic area information, ranging time period information, ranging distance accuracy information, or ranging direction accuracy information.

In some embodiments, the processing unit 920 is further configured to: determine, in response to the identification of the first terminal device being in the terminal device list, that the privacy verification of the ranging request message passes; and determine, in response to the identification of the first terminal device being not in the terminal device list, that the privacy verification of the ranging request message fails.

In some embodiments, the processing unit 920 is further configured to: determine, in response to the identification of the first terminal device and the identification of the third terminal device being both in the terminal device list, that the privacy verification of the ranging request message passes; and determine, in response to the identification of the first terminal device and/or the identification of the third terminal device being not in the terminal device list, that the privacy verification of the ranging request message fails.

In some embodiments, the processing unit 920 is further configured to: determine the number of auxiliary terminal devices triggered by the third terminal device; determine, in response to the number of auxiliary terminal devices triggered by the third terminal device being less than or equal to the restriction information on the number of auxiliary terminal devices, that the privacy verification of the ranging request message passes; and determine, in response to the number of auxiliary terminal devices triggered by the third terminal device being greater than the restriction information on the number of auxiliary terminal devices, that the privacy verification of the ranging request message fails.

In some embodiments, the processing unit 920 is further configured to: determine, in response to the identification of the first terminal device being in the terminal device list and the ranging information being all in compliance with restriction information in the privacy profile, that the privacy verification of the ranging request message passes.

In some embodiments, in response to the privacy verification of the ranging request message failing, the ranging response message is used to reject the ranging request from the first terminal device.

In some embodiments, the processing unit 920 is further configured to: perform integrity verification of the ranging request message. In response to the integrity verification of the ranging request message failing, the ranging response message is used to reject the ranging request from the first terminal device.

In some embodiments, in response to the integrity verification of the ranging request message and the privacy verification of the ranging request message passing, the ranging response message is used to determine to accept the ranging request from the first terminal device.

The ranging apparatus according to embodiments of the present disclosure, the ranging request message sent by the first terminal device is received, the privacy verification is performed on the ranging request message based on the privacy profile stored on the second terminal device, and the ranging response message is sent to the first terminal device, with the ranging response message being used to determine whether to accept the ranging request, so that the first terminal device needs to pass the privacy verification performed by the second terminal device and obtain permission from the second terminal device before performing the ranging service, to obtain the distance and the direction of the second terminal device to be ranged, effectively protecting the privacy of the terminal device from being leaked, and improving the security of the system.

As shown in FIG. 10, a schematic diagram of a structure of a ranging apparatus according to embodiments of the present disclosure is provided.

As shown in FIG. 10, the ranging apparatus 1000 includes a sending unit 1010, and a receiving unit 1020.

The sending unit 1010 is configured to send a ranging request message to a second terminal device. The ranging request message is used to request for ranging to be performed on the second terminal device.

The receiving unit 1020 is configured to receive a ranging response message sent by the second terminal device. The ranging response message is used to determine whether to accept a ranging request.

In some embodiments, the ranging request message includes identification of the first terminal device, identification of the second terminal device, and a ranging type, and the ranging type includes the ranging request directly initiated by the first terminal device, or the ranging request initiated by the first terminal device under trigger of a third terminal device.

In some embodiments, in response to the ranging type being ranging triggered by the third terminal device, the ranging request message further includes identification of the third terminal device.

In some embodiments, the ranging request message further includes ranging information, and the ranging information includes at least one of: ranging geographic area information, ranging time period information, ranging distance accuracy information, or ranging direction accuracy information.

In some embodiments, the apparatus further includes a processing unit (not shown in the figure). The processing unit is configured to perform integrity verification of the ranging response message.

The processing unit is further configured to reject the ranging response message in response to the integrity verification of the ranging response message failing.

The ranging apparatus according to embodiments of the present disclosure, the ranging request message is sent to the second terminal device, with the ranging request message being used to request for ranging to be performed on the second terminal device, and the ranging response message sent by the second terminal device is received, with the ranging response message being used to determine whether to accept the ranging request, so that the first terminal device needs to pass the privacy verification performed by the second terminal device and obtain permission from the second terminal device before performing the ranging service, to obtain the distance and the direction of the second terminal device to be ranged, effectively protecting the privacy of the terminal device from being leaked, and improving the security of the system.

In order to implement the above embodiments, the present disclosure also proposes a communication device including a processor and a memory. The memory stores a computer program, and the processor is configured to execute the computer program stored in the memory to cause the methods shown in embodiments of FIGS. 2 and 3 to be performed by the device.

In order to implement the above embodiments, the present disclosure also proposes a communication device including a processor and a memory. The memory stores a computer program, and the processor is configured to execute the computer program stored in the memory to cause the methods shown in embodiments of FIGS. 4 to 6 to be performed by the device.

In order to implement the above embodiments, the present disclosure also proposes a communication device including a processor and an interface circuit. The interface circuit is configured to receive and transmit code instructions to the processor, and the processor is configured to run the code instructions to cause the methods shown in embodiments of FIGS. 2 and 3 to be performed.

In order to implement the above embodiments, the present disclosure also proposes a communication device including a processor and an interface circuit. The interface circuit is configured to receive and transmit code instructions to the processor, and the processor is configured to run the code instructions to cause the methods shown in embodiments of FIGS. 4 to 6 to be performed.

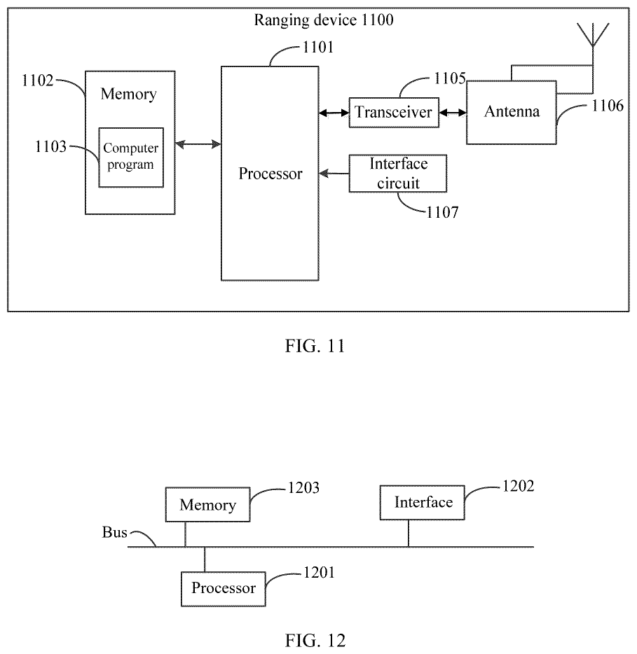

As shown in FIG. 11, a schematic diagram of a schematic diagram of a structure of a device for ranging according to embodiments of the present disclosure is provided. The device 1100 for ranging can be a network device or a terminal device. The device 1100 for ranging can also be a chip, a chip system, or a processor that supports the network device to implement the above methods, or a chip, a chip system, or a processor that supports the terminal device to implement the above methods. The device can be used to implement the methods described in the above method embodiments. Specifically, reference can be made to the description in the above method embodiments.

The ranging device 1100 can include one or more processors 1101. The processor 1101 can be a general-purpose processor or a dedicated processor, etc. For example, the processor can be a baseband processor or a central processor. The baseband processor can be used to process communication protocols and communication data, and the central processor can be used to control the ranging device (such as base stations, baseband chips, terminal devices, terminal device chips, DU or CU, etc.), execute computer programs, and process computer program data.

In some embodiments, the ranging device 1100 can also include one or more memories 1102, and a computer program 1103 can be stored on the memory. The processor 1101 can execute the computer program 1103 to cause the ranging device 1100 to implement the methods described in the above embodiments. The computer program 1103 can be solidified in the processor 1101, in which case the processor 1101 can be implemented through hardware.

In some embodiments, data can also be stored in the memory 1102. The ranging device 1100 and the memory 1102 can be arranged separately or integrated together.

In some embodiments, the ranging device 1100 can also include a transceiver 1105 and an antenna 1106. The transceiver 1105 can be referred to as a transceiver unit, a transceiver machine, or a transceiver circuit, etc., and can be used to achieve a transceiving function. The transceiver 1105 can include a receiver and a transmitter. The receiver can be referred to as a receiver or a receiver circuit, etc., and is used to achieve a receiving function. The transmitter can be referred to as a transmitter or a transmitter circuit, etc., and is used to achieve a transmitting function.

In some embodiments, the ranging device 1100 can also include one or more interface circuits 1107. The interface circuit 1107 is used to receive code instructions and transmit the code instructions to the processor 1101. The processor 1101 executes the code instructions to cause the ranging device 1100 to implement the methods described in the above method embodiments.

In some embodiments, the processor 1101 can include a transceiver for achieving receiving and transmitting functions. For example, the transceiver can be a transceiver circuit, an interface, or an interface circuit. The transceiver circuit, interface, or interface circuit used to achieve receiving and transmitting functions can be separate or integrated together. The above-mentioned transceiver circuit, interface or interface circuit can be used for reading and writing codes/data, or the above-mentioned transceiver circuit, interface or interface circuit can be used for transmitting or transferring signals.

In some embodiments, the ranging device 1100 can include a circuit that can achieve receiving, transmitting, or communicating functions as described in the above method embodiments. The processor and the transceiver described in the present disclosure can be realized on the integrated circuit (IC), analog IC, radio frequency integrated circuit (RFIC), mixed signal IC, application specific integrated circuit (ASIC), printed circuit board (PCB), electronic device, and the like. The processor and the transceiver can also be manufactured using various IC process technologies, such as complementary metal oxide semiconductor (CMOS), N-type metal oxide semiconductor (NMOS), P-type metal oxide semiconductor (PMOS), bipolar junction transistor (BJT), bipolar CMOS (BiCMOS), silicon germanium (SiGe), gallium arsenide (GaAs), etc.

The ranging device described in the above embodiments can be a network device or a terminal device, but the ranging device described in the present disclosure is not limited to this, and the structure of the ranging device may not be limited by FIGS. 9 and 10. The ranging device can be an independent device or can be part of a larger device. For example, the ranging device can be at least one of:
(1) Independent integrated circuit ICs, or chips, or chip systems or subsystems.
(2) A set including one or more ICs, which can optionally also include storage components for storing data and computer programs.
(3) ASICs, for example, a modem.
(4) Modules that can be embedded in other devices.
(5) Receivers, terminal devices, intelligent terminal devices, cellular phones, wireless devices, handheld devices, mobile units, vehicle mounted devices, network devices, cloud devices, artificial intelligence devices, etc.
(6) Other devices and so on.

For the case where the ranging device can be a chip or a chip system, reference is made to the schematic diagram of a structure of the chip shown in FIG. 12. The chip shown in FIG. 12 includes a processor 1201 and an interface 1202. In some embodiments, the number of processors 1201 can be one or more, and the number of interfaces 1202 can be multiple.

For the case where the chip is used to implement the functions of network devices in some embodiments of the present disclosure:
the interface 1202 is configured to receive and transmit code instructions to the processor; and
the processor 1201 is configured to run the code instructions to perform the methods shown in FIGS. 2 and 3.

For the case where the chip is used to implement the functions of network devices in some embodiments of the present disclosure:
the interface 1202 is configured to receive and transmit code instructions to the processor; and
the processor 1201 is configured to run the code instructions to perform the methods shown in FIGS. 4 and 5.

In some embodiments, the chip further includes a memory 1203 configured for storing necessary computer programs and data.

Those skilled in the art can also understand that the various illustrative logical blocks and steps listed in the embodiments of the present disclosure can be achieved through electronic hardware, computer software, or a combination of both. Whether a function is achieved through hardware or software depends on the specific application and design requirements of the overall system. Those skilled in the art can use various methods to achieve the described functions for each specific application, but such achievement should not be understood as beyond the protection scope of the present disclosure.

Embodiments of the present disclosure also provide a communication system, which includes a ranging device serving as a terminal device in the aforementioned embodiments of FIGS. 9 and 10, or the system includes a ranging device serving as a terminal device in the aforementioned embodiment of FIG. 11.

The present disclosure also provides a readable storage medium on which instructions are stored, and when the instructions are executed by a computer, the functions of any of the above method embodiments are achieved.

The present disclosure also provides a computer program product that achieves the functions of any of the above method embodiments when executed by a computer.

The above embodiments can be fully or partially implemented through software, hardware, firmware, or any combination thereof. When implemented using software, the embodiments can be fully or partially implemented in the form of a computer program product. The computer program product includes one or more computer programs. When the computer programs are loaded and executed on the computer, all or part of the processes or functions described in the embodiments of the present disclosure are generated. The computer can be a general-purpose computer, a dedicated computer, a computer network, or other programmable devices. The computer program can be stored in a computer-readable storage medium or transmitted from one computer-readable storage medium to another. For example, the computer program can be transmitted from a website site, a computer, a server, or a data center via wired (such as coaxial cable, optical fiber, digital subscriber line (DSL)) or wireless (such as infrared, wireless, microwave, etc.) communication, to transmit to another website, computer, server, or data center. The computer-readable storage medium can be any available medium that the computer can access, or a data storage device such as a server, a data center, etc. that integrates one or more available media. The available media can be magnetic media (such as floppy disks, hard drives, magnetic tapes), optical media (such as high-density digital video discs (DVDs)), or semiconductor media (such as solid state disks (SSDs)), etc.

Those of ordinary skill in the art can understand that the first, second, and other numerical numbers involved in the present disclosure are only for the convenience of description and differentiation, and are not used to limit the scope of embodiments of the present disclosure, but also indicate an order.

At least one in the present disclosure can also be described as one or more, where more can be two, three, four, or more, which is not limited in the present disclosure. In embodiments of the present disclosure, “first”, “second”, “third”, “A”, “B”, “C”, and “D” can be used to distinguish different technical features described, and the technical features described using “first”, “second”, “third”, “A”, “B”, “C”, and “D” are not distinguished from each other in an order or a magnitude.

The corresponding relationships shown in each table in the present disclosure can be configured or predefined. The values of the information in each table are only examples and can be configured to other values, which is not limited in the present disclosure. When configuring the correspondence between information and various parameters, it is not necessary to configure all the correspondence shown in each table. For example, in the table of the present disclosure, the correspondence shown in certain rows may not be configured. For example, appropriate deformation adjustments can be made based on the above table, such as splitting, merging, etc. The names of the parameters shown in the titles of the above tables can also use other names that can be understood by the communication device, and the values or representations of the parameters can also use other values or representations that can be understood by the communication device. When implementing the above tables, other data structures can also be used, such as arrays, queues, containers, stacks, linear tables, pointers, linked lists, trees, graphs, structures, classes, heaps, hash tables, etc.

The term predefined in the present disclosure can be understood as defined, defined in advance, stored, stored in advance, negotiated in advance, configured in advance, solidified in advance, or fired in advance.

Those of ordinary skill in the art can realize that units and algorithm steps of each example described in embodiments of the present disclosure can be implemented in electronic hardware, or a combination of computer software and electronic hardware. Whether these functions are implemented in hardware or software depends on the specific application and design constraints of the technical solution. The skilled person can use different methods to achieve the described functions for each specific application, but such achievement should not be considered as beyond the scope of the present disclosure.

Those skilled in the art can clearly understand that for the convenience and conciseness of the description, the specific working processes of the system, device, and unit described above can refer to the corresponding processes in the above method embodiments, which will not be repeated here.

It should be understood that various forms of processes shown in the above can be used to reorder, add, or delete steps. For example, the steps described in some embodiments of the present disclosure can be executed in parallel, sequentially, or in different orders, as long as the desired results of the technical solutions disclosed can be achieved, which is not limited in the present disclosure.

The above specific implementations do not constitute limitations on the protection scope of the present disclosure. Those skilled in the art should understand that various modifications, combinations, sub-combinations, and substitutions can be made based on design requirements and other factors. Any modifications, equivalent substitutions, and improvements made within the spirit and principles of the present disclosure shall be included within the protection scope of the present disclosure.

1. A ranging method, performed by a second terminal device, the method comprising:
receiving a ranging request message sent by a first terminal device;
performing privacy verification of the ranging request message based on a privacy profile stored on the second terminal device; and
sending a ranging response message to the first terminal device, wherein the ranging response message is used to determine whether to accept a ranging request of the ranging request message.

2. The method according to claim 1, wherein the privacy profile comprises at least one of following information:
a terminal device list comprising identification of at least one terminal device allowed to be connected to the second terminal device;
ranging type restriction information;
ranging geographic area restriction information;
ranging time period restriction information;
ranging distance accuracy restriction information;
ranging direction accuracy restriction information; or
restriction information on number of auxiliary terminal devices.

3. The method according to claim 2, wherein the ranging request message comprises identification of the first terminal device, identification of the second terminal device, and a ranging type, and the ranging type comprises a first type of a ranging request directly initiated by the first terminal device, or a second type of a ranging request initiated by the first terminal device under trigger of a third terminal device.

4. The method according to claim 3, wherein in response to the ranging type being the second type of the ranging request initiated by the first terminal device under the trigger of the third terminal device, the ranging request message further comprises identification of the third terminal device.

5. The method according to claim 3, wherein the ranging request message further comprises ranging information, and the ranging information comprises at least one of:
ranging geographic area information, ranging time period information, ranging distance accuracy information, or ranging direction accuracy information.

6. The method according to claim 3, wherein performing the privacy verification of the ranging request message based on the privacy profile stored on the second terminal device, comprises:
determining, in response to the identification of the first terminal device being in the terminal device list, that the privacy verification of the ranging request message passes; and
determining, in response to the identification of the first terminal device being not in the terminal device list, that the privacy verification of the ranging request message fails.

7. The method according to claim 4, wherein performing the privacy verification of the ranging request message based on the privacy profile stored on the second terminal device, comprises:
determining, in response to the identification of the first terminal device and the identification of the third terminal device being both in the terminal device list, that the privacy verification of the ranging request message passes; and
determining, in response to at least one of the identification of the first terminal device or the identification of the third terminal device being not in the terminal device list, that the privacy verification of the ranging request message fails.

8. The method according to claim 7, wherein performing the privacy verification of the ranging request message based on the privacy profile stored on the second terminal device, comprises:
determining the number of auxiliary terminal devices triggered by the third terminal device;
determining, in response to the number of auxiliary terminal devices triggered by the third terminal device being less than or equal to the restriction information on the number of auxiliary terminal devices, that the privacy verification of the ranging request message passes; and
determining, in response to the number of auxiliary terminal devices triggered by the third terminal device being greater than the restriction information on the number of auxiliary terminal devices, that the privacy verification of the ranging request message fails.

9. The method according to claim 5, wherein performing the privacy verification of the ranging request message based on the privacy profile stored on the second terminal device, comprises:
determining, in response to the identification of the first terminal device being in the terminal device list and the ranging information being all in compliance with restriction information in the privacy profile, that the privacy verification of the ranging request message passes.

10. The method according to claim 3, wherein in response to the privacy verification of the ranging request message failing, the ranging response message is used to reject the ranging request from the first terminal device.

11. The method according to claim 1, further comprising:
performing integrity verification of the ranging request message;
wherein in response to the integrity verification of the ranging request message failing, the ranging response message is used to reject the ranging request from the first terminal device.

12. The method according to claim 11, wherein in response to the integrity verification of the ranging request message and the privacy verification of the ranging request message passing, the ranging response message is used to accept the ranging request from the first terminal device.

13. A ranging method, performed by a first terminal device, the method comprising:
sending a ranging request message to a second terminal device, wherein the ranging request message is used to request for ranging to be performed on the second terminal device; and
receiving a ranging response message sent by the second terminal device, wherein the ranging response message is used to determine whether to accept a ranging request of the ranging request message.

14. The method according to claim 13, wherein the ranging request message comprises identification of the first terminal device, identification of the second terminal device, and a ranging type, and the ranging type comprises a first type of a ranging request directly initiated by the first terminal device, or a second type of a ranging request initiated by the first terminal device under trigger of a third terminal device.

15. The method according to claim 14, wherein in response to the ranging type being ranging triggered by the third terminal device, the ranging request message further comprises identification of the third terminal device.

16. The method according to claim 14, wherein the ranging request message further comprises ranging information, and the ranging information comprises at least one of:
ranging geographic area information, ranging time period information, ranging distance accuracy information, or ranging direction accuracy information.

17. The method according to claim 13, further comprising:
performing integrity verification of the ranging response message; and
rejecting the ranging response message in response to the integrity verification of the ranging response message failing.

18-34. (canceled)

35. A communication device comprising a processor and a memory, wherein the memory stores a computer program, and the processor is configured to execute the computer program stored in the memory, to cause the method according to claim 1 to be performed by the device.

36. A communication device comprising a processor and a memory, wherein the memory stores a computer program, and the processor is configured to execute the computer program stored in the memory, to cause the method according to claim 13 to be performed by the device.

37-38. (canceled)

39. A non-transitory computer-readable storage medium having instructions stored thereon, which when executed, cause the method according to claim 1 to be implemented.

40. (canceled)
